(19) United States
(12) Patent Application Publication
(10) Pub. No.: US 2007/0070819 A1
(43) Pub. Date: Mar. 29, 2007

(54) Linear time display

(75) Inventors: Jehangir Choksi, London (GB); Denis Zimmermann, Kreuzlingen (CH)

Correspondence Address: YOUNG & THOMPSON, 745 SOUTH 23RD STREET, 2ND FLOOR, ARLINGTON, VA, 22202, US

(73) Assignee: RICHEMONT INTERNATIONAL SA, VILLARS-SUR-GLANE (CH)

(21) Appl. No.: 11/514,104

(22) Filed: Sep. 1, 2006

(30) Foreign Application Priority Data
Dec. 3, 2005 (EP) 05026430.8
Sep. 5, 2005 (CH) 01448/05

(51) Int. Cl. G04B 19/00; G04B 25/00

(52) U.S. Cl. 368/76; 368/223

(57) ABSTRACT

A time display device has at least one linear scale subdivided into at least two parallel scale sections arranged side by side. The divisions of the sections are plotted in opposite directions. The device includes guiding elements running between these scale sections, and at least one member attached to the guiding elements and movable along the linear scale sections. This member also has driving elements moving it, and display elements attached to the member for displaying time on the scale sections. The display elements are attached to the member such that each time when reaching the end of a linear scale section, they will turn from one scale section to the other. The turning occurs at least partially in a jumping and instantaneous manner. As an alternative to this feature, the turning may also occur by a linear motion of the display elements.

The present invention relates to a time display device with at least one linear scale divided into at least two parallel scale sections arranged side by side and having their scale divisions plotted in opposite directions, with guiding elements running between these sections, with at least one member attached to the guiding elements and movable along the linear scale sections, with driving means moving this member, and with display means attached to this member for the display of time on the scale sections.

Linear time displays of this kind are known, for instance, from patent documents EP 0,509,965 or U.S. Pat. No. 2,221,413. The mechanisms reported there have a pointer guided along the two straight-line sections of the scale that are positioned side by side, the pointer changing its direction of motion at each end of the linear sections by a semicircular turn facing outward and being returned along the other linear scale section. The pointer thus moves along a track consisting of two semicircular ends linked by two elongated straight central sections, rather than along the customary circular track of an ordinary timepiece. It is fundamentally impossible, however, to attain a true linear display with this design, since the display is of course nonlinear in the radial track portions. Moreover, the linear track portion is perceptibly shortened relative to the radial track portion, to an extent that depends on the turning radius that must be provided toward the outside, depending on the size of the pointer, which partly offsets the aesthetically desired effect of a linear display.

A device aiming at the same aesthetic effect is known from patent application EP 1,416,339, the display in this case occurring in fact exclusively linearly. However, here the pointer simultaneously extends over both of the scale sections that are positioned side by side, and thus makes the display difficult to read unless an unambiguous indication is given which of the two sections must be read. An additional display of the direction of travel of the driving device proposed in this document merely yields a moderate improvement of legibility of the device.

It is the aim of the present invention to realize a purely linear display for a time-measuring instrument that avoids the precited disadvantages of known systems while more particularly aiming at fully exploiting the aesthetic effect of a linear display, using linear display sections exclusively, and by an appropriate technical realization of motions of the display elements at the ends of the linear scale sections not giving rise to restrictions concerning the design solutions.

Thus, object of the present invention is a time display device having the characteristics of claim 1 or claim 20.

According to claim 1, the device that is the object of the invention is characterized to that effect, more particularly by display means attached in such a way to the member that is movably attached to the guiding means that, when reaching one of the ends of a linear scale section, they will turn over to the other scale section, the turn occurring at least partially in a jumping and instantaneous manner. This is advantageous, in that on the one hand linear scale sections alone may be used so as to reinforce the aesthetic effect, and that on the other hand it is unambiguously clear from the display at any time which of the sections should be read. This will be true more particularly when the display means are attached to said member in such a way that, when attaining any of the ends of a linear scale section, they turn over to the scale section running parallel to it, in an entirely jumping and instantaneous manner, that is, the turning occurs at once in a single jump in the instant when the end of a linear section has been attained.

Further design options are opened up in such a linear display, more particularly because of the fact that the display means are attached to said member in such a way that the turning motion will occur in a direction perceptibly pointing toward the center of the time display device. This implies that the linear scale sections are not restricted in their longitudinal extent by the space requirements of a turning circle of the display means that is pointing toward the outside, as in the prior art.

The device that is object of the invention according to claim 20 attains the same precited advantages by an attachment of the display means to said member that is an alternative to that of claim 1, and that is such that upon reaching the end of a linear scale section, they turn over from one scale section to the other while the turning involves a linear motion of the display means.

Further developments of these two basic design options of the device reside in the selection of the guiding and display means, and above all of the driving means and associated layout of the member that interacts with them and is movably attached to the guiding means.

Their advantages result from the features cited in the dependent claims, and from the description setting forth the invention in detail in what follows, with the aid of drawings.

The appended drawings represent schematically and by way of example several embodiments of a linear display according to the present invention.

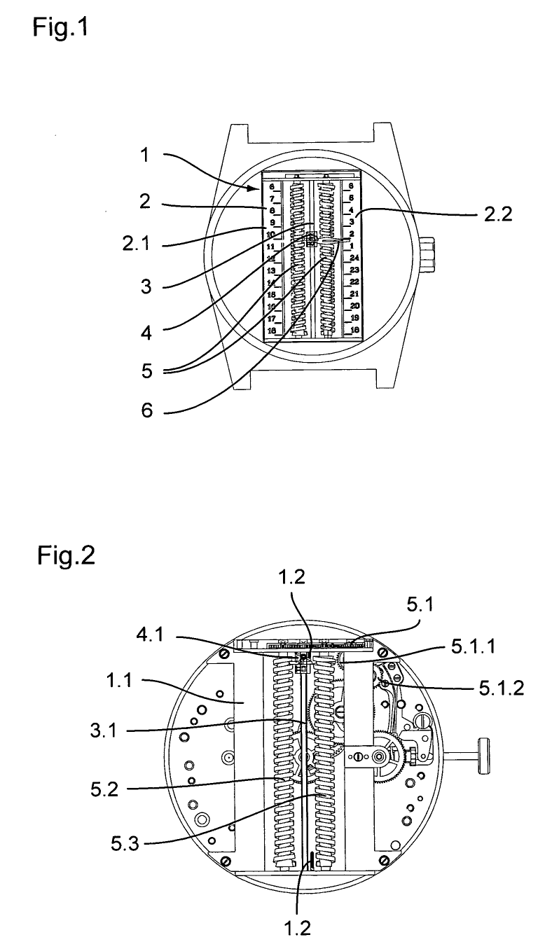

FIG. 1 schematically illustrates the principle of a linear display device according to the invention.

FIG. 2 is a schematic view of a movement integrating such a linear display device.

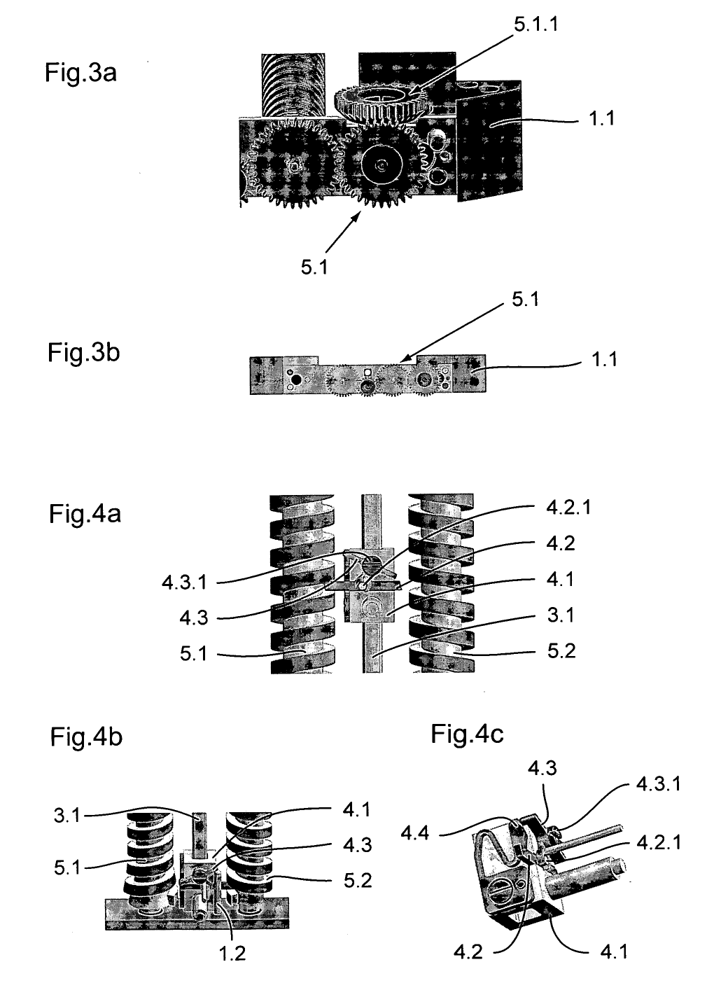

FIGS. 3a and 3b represent frame and gear train of the base module of the display device in greater detail in perspective and from the front.

FIGS. 4a, 4b and 4c are detailed views of the interplay between the mobile member, the guiding means, and the screws of the driving means.

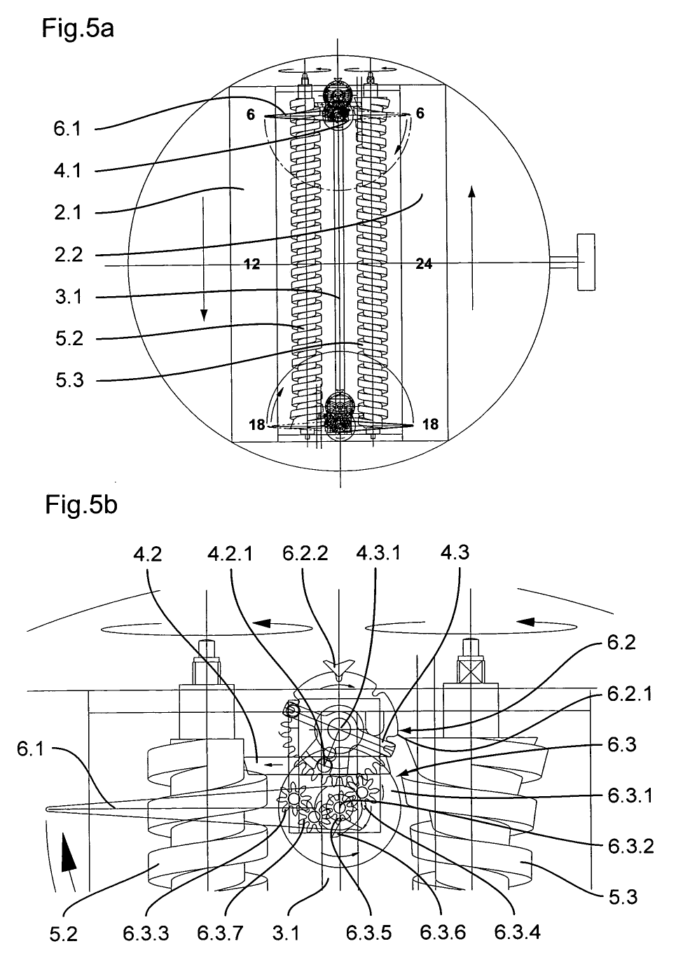

FIG. 5a shows a first embodiment of the display means and their arrangement on the mobile member according to the present invention, the pointer positions being shown, both in the original place and after the turn, and for both scale ends; FIG. 5b is an enlarged view of the display means of FIG. 5a explaining the variable transmission.

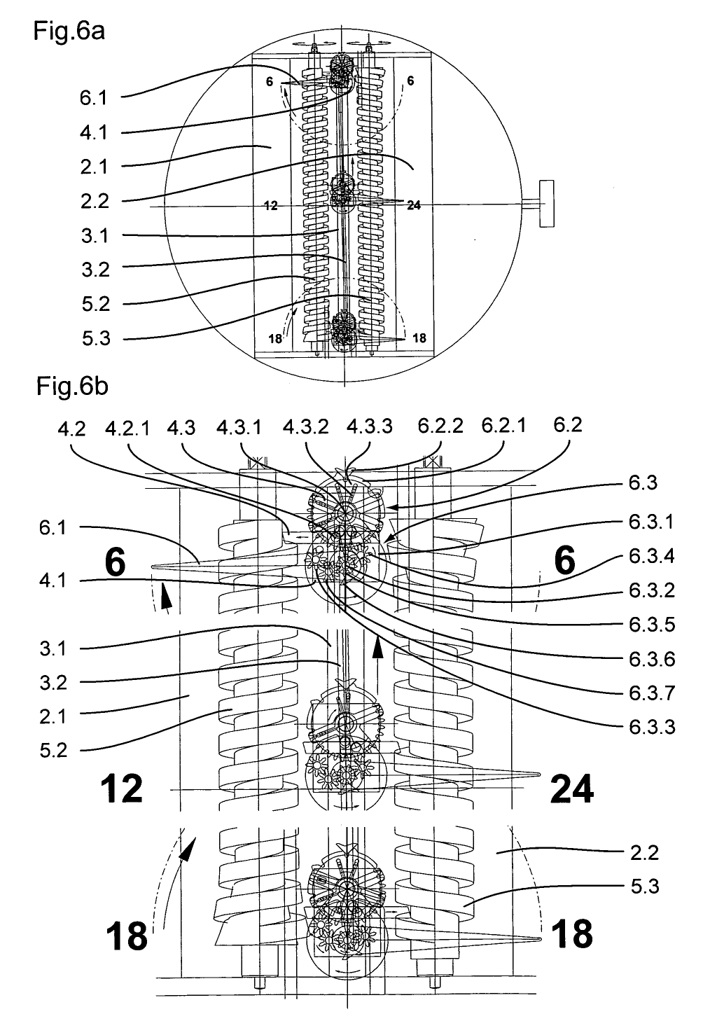

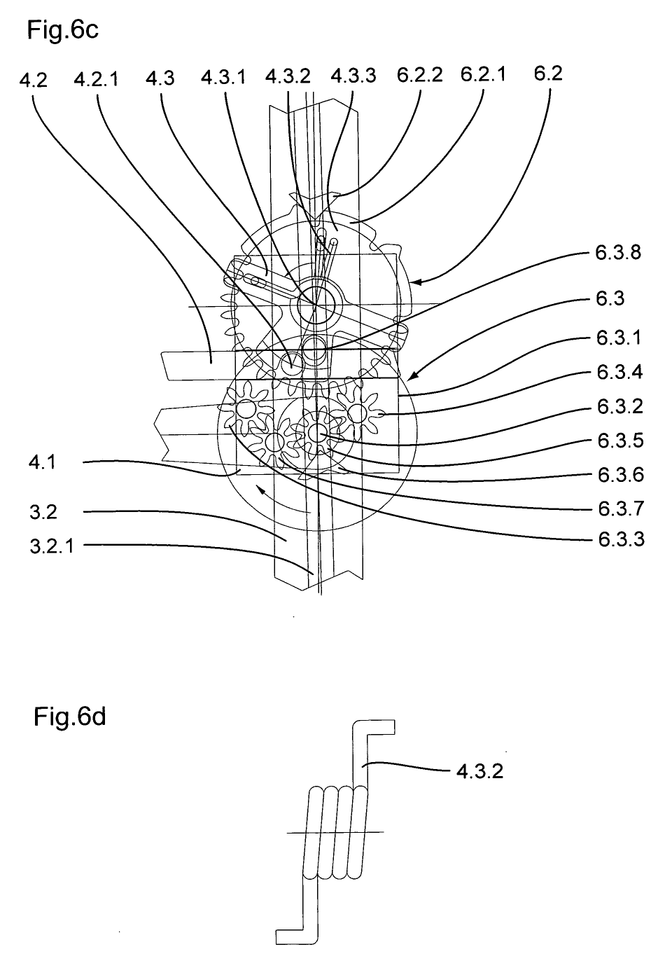

FIG. 6a is a view of a second embodiment of the display means and of their arrangement on the mobile member according to the present invention, the pointer positions being shown at the two scale ends and at scale center; FIG. 6b shows enlarged views of the display means of FIG. 6a in the three positions represented there, to explain the reversing and turning means; FIG. 6c is a detailed view of these display means in descending motion and of the associated guiding means; FIG. 6d shows the pretensioning spring of the reversing means.

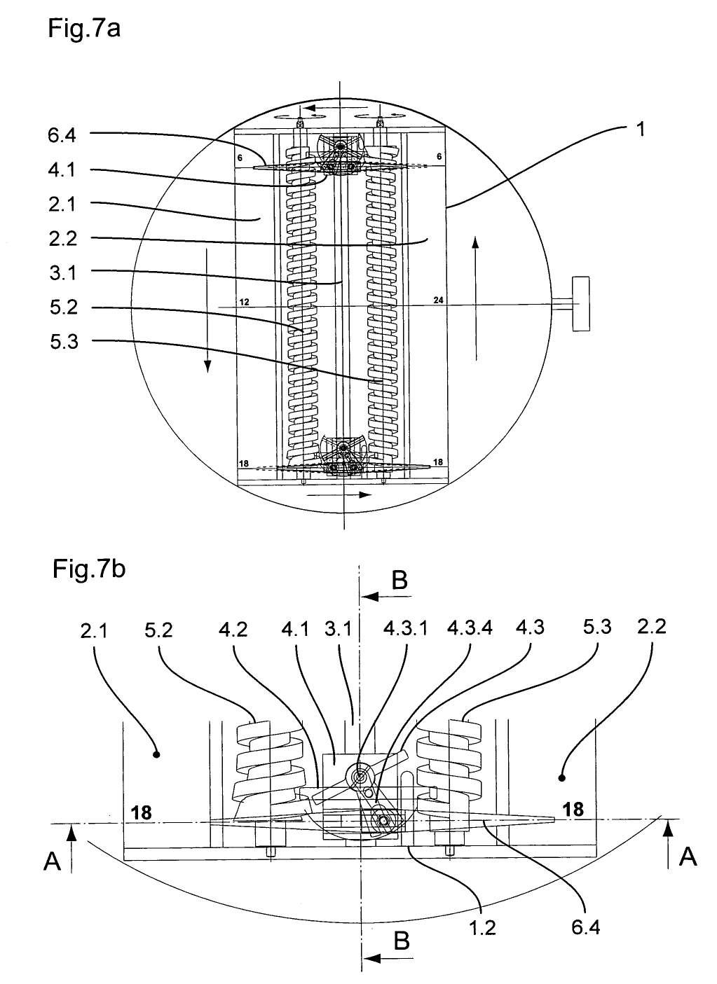

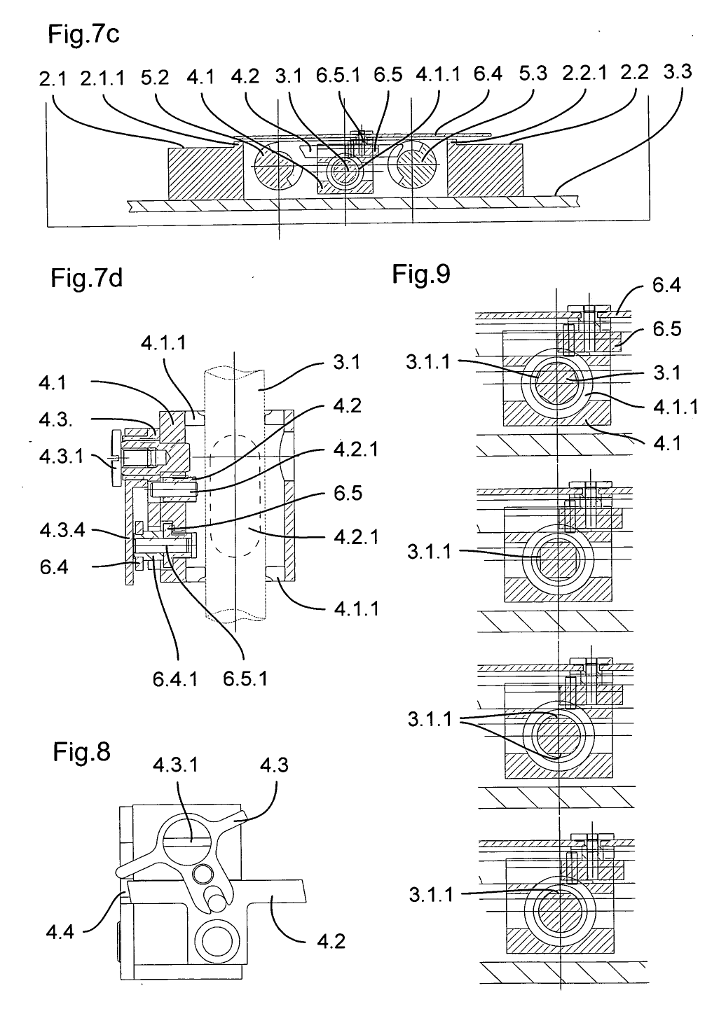

FIG. 7a is a top view of a third embodiment of the display means and their arrangement on the mobile member according to the present invention, the pointer positions being shown in their original place and after the turn, and for both scale ends; FIG. 7b is an enlarged view of the display means of FIG. 7a explaining the linear turning means; FIG. 7c is a sectioned view along the line A-A of FIG. 7b; and FIG. 7d is a sectioned view along the line B-B of FIG. 7b.

FIG. 8 illustrates a mobile member according to the present invention lacking separate linear turning means.

FIG. 9 represents several cross-section shapes of the guiding means in a schematic and exemplary fashion.

In the following the invention will be described in detail with the aid of the figures mentioned.

Referring to FIG. 1, the principle of a linear display device according to the present invention will first be explained. Such a time display device 1 includes at least one linear scale 2 subdivided into an even number of parallel scale sections 2.1, 2.2 that are positioned side by side and have equal lengths, at least two sections being required for each scale 2, as shown in FIG. 1. Their divisions are plotted in opposite directions, and could concern, not only a display of hours as in the case sketched, but equally well a display of minutes or seconds, for instance. Between these scale sections 2.1, 2.2, guiding means 3 are arranged which support at least one member 4 that is movably attached to them and is guided along the linear scale sections 2.1, 2.2. If there was a further scale extending the scale sections sketched in FIG. 1, for instance a scale indicating minutes, then the guiding means 3 could support a further member serving said purpose. In addition, driving means 5 are provided that move the organ or organs 4. Attached to each member 4 are display means 6 for a time display on scale sections 2.1, 2.2. At any given point in time, the display means 6 only point to one of the linear scale sections 2.1, 2.2, and they are attached in such a way to said member 4 that when reaching one end of a linear scale section 2.1, 2.2, they will turn over from one scale section to the other scale section positioned next to it. Here, appropriate turning means are provided in the first and second embodiments of the device that is object of the invention, to be described in greater detail in what follows, so that the turning will occur at least partially in a jumping and instantaneous manner so as to guarantee that the display may be read unambiguously. In the third embodiment of the device that is object of the invention and will be described later on, turning means are provided that make possible a linear turning motion. Such a linear display functions so that after having traveled a linear scale section in one direction, the display means 6 turn over in order to travel the neighboring scale section in the opposite direction, then turn over again to resume the same process. In this way a clearly legible, purely linear display can be realized. The notion of “turning over” must be interpreted broadly in this context, in that it may signify a redirection by rotary motion or by linear motion.

A timepiece, and more particularly a wristwatch, that includes a time display device 1 according to the invention may be subdivided into structural components serving in the closer description that follows next, viz., first, an ordinary watch case including the corresponding movement, secondly, a base module forming the mechanical structure of the linear display that is cooperating with the movement, and finally, a display module movably arranged on the base module that houses the display means. The latter two modules taken together constitute a linear display according to the present invention, in the different embodiments of these modules, and will now be explained in detail.

These two modules may then be fixedly mounted on any mechanical or electronic base movement of corresponding size, parallel to said movement and in any desired angular orientation relative to the customary 6-o'clock—12-o'clock-line of a timepiece with hands, as shown in FIG. 2, and with minor adjustments or no adjustments at all. The timepiece intended to integrate the display may be a wristwatch as represented in FIG. 2, or any other type of timepiece, for instance an upright clock.

In the embodiment sketched in FIG. 2, the base module includes a frame 1.1 constituting the mechanical base structure, a driving gear train 5.1 and two screws 5.2, 5.3 serving as the driving means 5, and a guide rail 3.1 serving as guiding means 3. Frame 1.1 and with it the time display device 1 as a whole could also be in a slightly tilted position, that is, not parallel to the movement. Frame 1.1 could equally well be mounted on a pivot bearing, for instance, and thus the time display device 1.1 could be controlled via an operating member at the watch case, manually or via a control mechanism within the movement, and adjusted manually or automatically to any angular position relative to their plane of assembly.

To frame 1.1, at least one linear scale 2 is attached that constitutes the dial of the timepiece, as it were, and may partially or completely cover up frame 1.1 and screws 5.2 and 5.3, respectively. Each scale 2 is subdivided into at least two parallel scale sections 2.1, 2.2 positioned side by side, as mentioned earlier, with scale divisions plotted in opposite directions, see FIG. 1.

The guide rail 3.1 or a so-called longitudinal guidance supporting a member 4 runs between these sections, and parallel to them. The geometric shape of the rail's cross section may be selected in different ways, as will be explained in greater detail below, alternatively the rail could be constituted by the scale sections 2.1, 2.2 forming the dial, the member 4 being guided between them; further variants of this kind can be imagined. Rail 3.1 could be enabled to move to and fro within frame 1.1 between the two screws 5.2, 5.3 with the aid of grooves (not shown) or smaller guides laterally mounted or machined into frame 1.1. This option of moving guide rail(s) 3.1 would make possible an engagement or disengagement by rail movement, to be explained later. Several guide rails could be attached in series or in parallel, each supporting at least one member 4, when several scales for the display of hours and minutes for example are present.

The two screws 5.2, 5.3 are mounted parallel to each other and to guide rail 3.1 within the plane of frame 1.1, so as to be able to rotate about their axes, and have helical threads. These threads have a triangular, trapezoidal, or rectangular profile, or another profile that is specially defined, and a pitch matched to the speed and direction of rotation of the screws, similar to a classical screw thread. As shown in FIG. 2, the helical threads of screws 5.2, 5.3 are running in opposite directions. As an alternative to this embodiment, one could imagine to use a single screw with double-helix thread. Two screws having the same thread but opposite directions of rotation are an equivalent, like further variants of this kind. Each screw may have conical ends on one or on both sides, as indicated in FIGS. 2 and 4b, serving a function be to explained later on.

The two screws 5.2, 5.3 are driven by the movement via driving gear train 5.1, and more particularly via a coupling wheel 5.1.1. In the embodiment shown in FIG. 2, which has a device 1 fixedly mounted on the timepiece, coupling wheel 5.1.1 is mounted idle on frame 1.1 on the side of the movement, as seen in FIGS. 3a and 3b. It is in a position parallel to the movement, and has first teeth directly engaged with an intermediate wheel 5.1.2 securing the transmission of force from the gear train of the movement, as well as second teeth constituting a so-called 90° or bevel-gear toothing engaged into an idle wheel of driving gear train 5.1 that is perpendicular to the plane of the movement. This wheel transmits the driving force to wheels attached to the ends of screws 5.2, 5.3, thus securing transmission of the forces as torques from the base movement of the timepiece to the driving means 5 of the base module of the time display device. With a frame 1.1 that together with the base module is mounted rotatably, appropriate designs known from tourbillon or karussel mechanisms can be employed. For reasons of perspicuity, these options will not be considered more closely in what follows.

It is an advantage of such a gear train 5.1 that it is immediately useful as drive for one or several screws 5.2, 5.3 involving corresponding rotations and directions of rotation in a variety of mechanisms, even as a basis for display functions other than those for hours and minutes, that is, a time display in the narrower sense, so for instance for time displays in timepieces such as the display of power reserve, of calendar data, of moon phases, of the duration of sunshine, or for chronographs, too. In principle, therefore, all display functions known or used thus far in timepieces may be driven without any restrictions by such a gear train 5.1 and screw-type parts 5.2, 5.3 of the kind described above.

Further, it is prior art to control the number of revolutions of the screws 5.2, 5.3 in all rotary positions in a synchronous, mutually independent, continuous or intermittent way or any combination of these options, using a mechanical calculating mechanism. Step motor technology controlled electronically would be an alternative.

In the example of FIG. 2, gear train 5.1 and its transmission are such that the two screws 5.2, 5.3 make two revolutions per hour in synchrony, and in the same direction of rotation. Of course, the transmission may be calculated and/or the design of gear train 5.1 may be adapted so as to match any time or other display that can be imagined, according to the selected scale 2.

In addition, a display module realizing the display function through the force transmitted from the movement via the base module is needed in order to secure the function of the time display device 1, as had been mentioned. This display module consists of at least one member 4 attached to the guiding means 3 so as to be mobile along the linear scale sections 2.1, 2.2, and of display means 6 arranged on the member and displaying time on the scale sections.

Preferably, member 4 is formed as a sliding carriage 4.1 that can be displaced along guide rail 3.1. In the field of classical mechanical engineering, such a slide is known as a linear stage for linear or ball guidances. Slide 4.1 holds the display means 6, as can be taken from FIG. 2, and will be shown in greater detail in FIGS. 4a to 4c as an example of member 4.

In this example, slide 4.1 is driven by screws 5.2, 5.3 with the aid of a guide beam or crossbar 4.2 that is arranged on it and can be moved in a direction perpendicular to the screw axis. To this end, crossbar 4.2 is engaged into the grooves of the helical thread of one of the screws 5.2, 5.3. When one of the screws 5.2, 5.3 is rotated in a given direction, slide 4.1 is pushed in the pitch direction of the screw thread while crossbar 4.2 is engaged into the thread of this screw, and thus it is guided in this direction on guide rail 3.1 along the associated scale section 2.1, 2.2. At the end of rail 3.1 and of screw 5.2, 5.3 or of the scale sections 2.1, 2.2, the direction of motion of the slide 4.1 must be inverted. The change of direction comes about by a lateral shift of crossbar 4.2 from one screw 5.2, 5.3 to the other screw facing it. In the example shown, the screw thread of the other screw is opposite, for a given direction of rotation, so slide 4.1 will now be transported in the other direction by the interplay between crossbar 4.2 and this screw. This mode of functioning also serves to clearly explain the alternatives mentioned above, for the design and arrangement of driving means 5 and screws 5.2, 5.3.

By a lateral shift of crossbar 4.2, the reversal of linear motion of member 4 is realized, hence it will be explained in greater detail with the aid of FIGS. 4a to 4c.

Crossbar 4.2 is inserted loosely with small play into an elongated groove of matching cross section at the surface of slide 4.1, and in its height is limited by a reversing lever 4.3 pivoted at a point of attachment 4.3.1. A control pin 4.2.1 serving to control the reversing lever 4.3 is arranged in the center of crossbar 4.2, as shown in FIG. 4a. When slide 4.1 has arrived at the end of guide rail 3.1 or of the screws 5.2, 5.3, as shown in FIG. 4b, then the conical end of the screw that had been mentioned above pushes the crossbar 4.2 that is engaged with minimum play in the screw thread, over to the other screw. This lateral shift of crossbar 4.2 that is controlled by the conical shape of the end of the screw, causes a pincer that is attached to the reversing lever 4.3 and is engaged into control pin 4.2.1, to rotate the reversing lever a certain angle about its point of attachment 4.3.1. It can be seen from FIG. 4c that at a certain angle of rotation, when its arm has slipped over the tip of a catch 4.4, reversing lever 4.3 snaps away from its first end position and into its second end position while pulling crossbar 4.2 completely over to the other side of slide 4.1 via control pin 4.2.1. Then crossbar 4.2 becomes engaged into the thread of the second screw, which brings the reversing operation to a close.

Positioning pins 1.2 may be arranged close to the screw ends, laterally inside of frame 1.1, as schematically shown in FIGS. 2 and 4b, to aid the movement of reversing lever 4.3 in a case where the lateral shift of crossbar 4.2 is not sufficiently large, for instance because of the play and safe distances existing between individual parts. These pins have an appropriate length, are arranged on one side of guide rail 3.1 that can be selected at will, and in the instance of possible problems push reversing lever 4.3 into its final, correct position while slide 4.1 continues its linear motion up to the end of the screw. A fine adjustment of the lengths of the positioning pins 1.2 may be performed by screw threads in an attachment at frame 1.1 in order to obtain a precisely timed triggering of the function. Other adjustments are possible, for instance by tightly adherent springs, sliding parts, and a scale. Depending on the length to which they are adjusted, even the positioning pins 1.2 themselves may serve as release pins, and as an economic alternative replace the conical screw ends that are difficult to machine.

Device 1 of the invention is distinguished primarily by the particular design of the display module and of display means 6, or their arrangement on member 4. For this reason, in what follows we are going to describe in detail three preferred embodiments of display means 6 and their arrangement on member 4 that had just been explained, as well as their cooperation with the base module.

The first variant consists of a display module having display means 6 that can be rotated through 180° toward the center of time display device 1, and will be explained in detail in what follows.

It can be seen from FIGS. 5a and 5b that display means 6 include a pointer 6.1 mounted rotatably in a plane parallel to the dial on member 4. FIG. 5a shows the direction in which the sole pointer 6.1 will jump, the original position of pointer 6.1 being given in dashed lines, and its final position after reversal being given in continuous lines; this is shown for the two scale ends at once, which of course is not real. Transparent representations have been chosen for FIGS. 5a and 5b in order to better visualize parts that are covered up, which does not reveal the layering of the parts in section, although this will become apparent from the context. Arrows in FIGS. 5a and 5b show the directions of rotation of screws 5.2 and 5.3, the direction of linear motion of slide 4.1, the direction of reversal of pointer 6.1, and the directions of rotation of the different wheels.

Display means 6 further comprise the means for reversing the pointer 6.1 which cooperate with member 4 or the parts attached to member 4, as shown in detail in FIG. 5b with the slide 4.1 located at the upper scale end. In the variant illustrated here, the means for reversal more particularly include a variable transmission 6.2 that cooperates with a crossbar 4.2 and control pin 4.2.1 functioning without a change as described above, and with reversing lever 4.3, as well as a motion work or dial train 6.3 that cooperates with variable transmission 6.2.

A toothed control disk 6.2.1 serving to control the dial train 6.3 is arranged between reversing lever 4.3 and slide body 4.1. Together with reversing lever 4.3, disk 6.2.1 is attached via control pin 4.2.1 at the point of attachment 4.3.1 so that these parts may rotate concentrically and in synchrony. The upper edge of disk 6.2.1 has two notches cooperating with a catch 6.2.2 here shown symbolically, each notch corresponding to one of the two extreme positions of reversing lever 4.3. Catch 6.2.2 produces a form-locking positioning of reversing lever 4.3 via control disk 6.2.1 and pin 4.2.1, either in addition to or in place of the above-mentioned catch 4.4 of slide 4.1. The lower edge of disk 6.2.1 has teeth within a certain sector which, depending on the position of a clutch disk 6.3.1, will engage with a first pinion 6.3.3 or a second pinion 6.3.4 sitting on this disk. Clutch disk 6.3.1 is freely pivoted on slide 4.1 in a point of rotation 6.3.2, and is connected in a form-locking and controllable manner with crossbar 4.2 via the pincers of reversing lever 4.3 or control pin 4.2.1.

By a shift of crossbar 4.2, this disk is rotated in two phases into one of the two positions corresponding to the extreme positions of reversing lever 4.3 or of the toothed control disk 6.2.1. In a first phase, the second pinion 6.3.4 (which like the first pinion 6.3.3 is mounted idle onto the clutch disk 6.3.1) is slowly pushed into the teeth of this disk by the movement of crossbar 4.2 in the upper position of slide 4.1 that is shown. In a second phase, control disk 6.2.1 still is driven by crossbar 4.2 via control pin 4.2.1, and is fully rotated into its final position while the second pinion 6.3.4 is engaged with control disk 6.2.1 and rotates together with it. A pointer pinion 6.3.5 that is always engaged with the two pinions 6.3.3, 6.3.4 and holds the pointer 6.1 is also rotated together with it. In this phase, therefore, pointer 6.1 follows, not only the rotating movement of the clutch disk but also that of the pointer pinion 6.3.5, in synchrony with the second pinion 6.3.4 and with the pointer pinion, respectively; all movements of these parts are symbolically indicated by arrows in FIG. 5b.

In this first variant of the display means 6 and means for reversal, pointer 6.1 in the above-mentioned first phase in summary at first moves slowly in the direction of the center of the time display device 1, while it follows the rotation of reversing lever 4.3 or control disk 6.2.1 and the associated rotation of clutch disk 6.3.1, this movement being well visible to the wearer. In the second phase, about half an hour before 6 o'clock and before slide 4.1 has reached the upper end of screw 5.3, a jumping and instantaneous movement of the pointer then takes place. That is, starting from a certain angle, the rotation of pointer 6.1 is accelerated when the reversing lever 4.3 hits the upper positioning pin 1.2, and finally, just before pointer 6.1 has completed half a turn, it suddenly is reversed. This is caused, on the one hand by the cooperation of catch 6.2.2 and the recess in control disk 6.2.1 as well as of a dial train catch 6.3.6 and pointer pinion 6.3.5 in the dial train 6.3, and on the other hand by the simultaneous rotation of clutch disk 6.3.1 and of the idle pinions of dial train 6.3 which are arranged on this disk and which have now become engaged with control disk 6.2.1. Thus, pointer 6.1 is now positioned on the opposite scale section by this combined two-phase movement, which can be regarded as a partially jumping and instantaneous reversing movement. The opposite constellation with slide 4.1 at the lower scale end is analogous, but here an intermediate gear 6.3.7 is inserted between the first pinion 6.3.3 and the pointer pinion 6.3.5.

This embodiment thus has display means 6 with a pointer 6.1 which, when reaching one end of a linear scale section 2.1, 2.2 will turn over from one scale section to the other, and in fact only partially in a jumping and instantaneous manner. This implies that the wearer, always during about half an hour before 6 o'clock in the morning and evening or, generally, just before the pointer turns over at the scale's end, will not be able to read the time entirely correctly, since relative to the scale, the pointer during this time is moving in the opposite direction, toward the center of the time display device 1. It may be desirable to avoid this effect, even though within the first few minutes this movement may be hardly noticeable to the wearer.

In the second variant of the display module, this is achieved by arranging the display means 6 on member 4 in such a way that they will turn over to the scale section that is located in parallel, in an entirely jumping and instantaneous manner when reaching any of the ends of a linear scale section 2.1, 2.2. Even here the display means are arranged on member 4, as in the earlier embodiment, advantageously in such a way that the turn occurs in a direction perceptibly pointing toward the center of the time display device 1, but this is not at all disturbing inasmuch as the turning occurs as a single sudden jump.

In this embodiment the means for reversal of member 4 include a pretensioning spring 4.3.2 helping to bring the reversing lever 4.3 via the positioning or release pins 1.2 on frame 1.1 in fractions of a second or at least within a few seconds automatically to the new position at the opposite screw 5.2, 5.3, so that pointer 6.1 is also rotated at once to the other scale section 2.1, 2.2 by the reversing means on the display means 6. Here, structure and function of the display means 6 are basically identical with those already described above in relation to the first variant, and are subject to only one important change, that is, a control of clutch disk 6.3.1 that is independent of reversing lever 4.3 and will be explained below. These two main differences, that is, an independent control of clutch disk 6.3.1 and the addition of a pretensioning spring 4.3.2 for reversing lever 4.3, have the effect that pointer 6.1 will move within the shortest possible time by half a turn from one scale section 2.1, 2.2 to the other. The advantage being that the wearer of the associated watch will practically always be able to exactly read the time, even while waiting for the pointer to jump over. For FIGS. 6a to 6d which are intended to illustrate this embodiment more closely, the explanations made in relation to FIGS. 5a and 5b are valid by analogy.

For the purpose of achieving the jumping function introduced in a general way above, a guide for instance in the guise of a further rail 3.2 will first be attached at frame 1.1, advantageously behind the guide rail 3.1. This guide, which will be called a control rail 3.2, includes a guide groove 3.2.1 diagonally crossing the surface of guide rail 3.1 facing the dial, as can be seen from FIGS. 6a and 6c. For the control of one or several slides 4.1 holding display means 6, and as technical equivalents, a number of variants of this design are of course possible. For instance, one may imagine a control rail forming a single body with the guide rail, so as to constitute a part that is more robust and safe in view of potential impacts from outside. One may further imagine to integrate one or several gear racks that could be used for the varied control and/or display functions mentioned above. For the sake of simplicity, these special designs will not be explained more closely here.

Contrary to the first variant, clutch disk 6.3.1 in the present case is no longer rotated via control pin 4.2.1 but its rotation is controlled via control rail 3.2 by a so-called clutch disk pin 6.3.8, which is integral with the clutch disk 6.3.1 and is engaged in guide groove 3.2.1 of the control rail 3.2 just mentioned. During the linear advance of slide 4.1 from the lower end of frame 1.1 to its upper end along guide rail 3.1, the clutch disk pin 6.3.8 is shifted laterally by the diagonally running guide groove 3.2.1 in control rail 3.2, as shown in FIG. 6c, and clutch disk 6.3.1 thus is rotated. Since the clutch disk 6.3.1 holds the dial train 6.3, the latter is rotated with it, and thus the first pinion 6.3.3 or the second pinion 6.3.4 is made to engage with the teeth of control disk 6.2.1 of the variable transmission 6.2, depending on the direction of linear motion of the slide, before the lower or upper final position of the slide is attained. The control of clutch disk 6.3.1 thus is independent of that of reversing lever 4.3, and the direction of rotation of pointer 6.1 is predefined by the position of the dial train 6.3 and more particularly by that of the clutch disk 6.3.1 relative to the variable transmission 6.2 and to control disk 6.2.1 until the reversal of the reversing lever 4.3 and with it the turning over of pointer 6.1 is triggered by the pretensioning spring 4.3.2 via a positioning pin 1.2.

Spring 4.3.2 which may be selected, for instance, as shown in FIG. 6d, is arranged around the point of attachment 4.3.1, one of its ends being hooked into a hole of reversing lever 4.3 and the other end being hooked into a first hole of a spring plate 4.3.3. This plate is freely pivoted in the point of attachment 4.3.1 on slide 4.1, and is controlled by the clutch disk pin 6.3.8 mentioned earlier which is engaged in a second hole of spring plate 4.3.3. On account of the lateral shift of clutch disk pin 6.3.8 that occurs, as mentioned above, during the linear advance of slide 4.1, spring plate 4.3.3 is rotated about a certain angle before the turning of the pointer is triggered at the end of scale sections 2.1, 2.2. This causes the pretensioning spring 4.3.2 to be uniformly and slowly pretensioned during a longer period of time, here over a maximum of 12 hours.

During the longitudinal movement of slide 4.1, the entire set of interacting parts: crossbar 4.2, reversing lever 4.3, and control disk 6.2.1, is held in place by catch 6.2.2 until a positioning pin 1.2 will act upon an arm of reversing lever 4.3. As soon as the force of catch 6.2.2 is overcome, the control disk 6.2.1 will be released and rotated by the stored energy of pretensioning spring 6.3.8 until catch 6.2.2 will engage into the other notch of control disk 6.2.1 corresponding to the other extreme position of reversing lever 4.3. Finally pointer 6.1 is brought into the correct position by dial train catch 6.3.6 that is engaged into the lobes of pointer pinion 6.3.5, by compensating the relatively large toothing plays. Otherwise, the different parts of the display module move according to the same pattern as explained in the above variant.

Even here, theoretically, pointer 6.1 will at first undertake a slight, oppositely directed movement before the jump to the oppositely located scale section 2.1, 2.2 is triggered. In practice, this backward movement is compensated by plays between the parts and more particularly between the teeth, so that a wearer will only perceive the jumping of pointer 6.1.

Theoretically, the dial train 6.3 on slide 4.1 may be supplemented to any extent desired with other designs. For instance, a minutes pointer may be added, or a rearrangement may be undertaken in order to realize other display functions of a linear time display according to the invention that had been mentioned above.

In a third variant, finally, the display module may have display means 6 that instead of being rotated, can be shifted linearly when executing said turn from one scale section to the other at the end of a linear scale section 2.1, 2.2. In this case the turn is realized, not by a rotary movement but by a linear movement of display means 6 occurring perpendicularly to the direction of movement of the member 4 that is mounted on the guiding means 3.

From the movement of the timepiece up to member 4 or slide 4.1 including the associated crossbar 4.2, the functioning of this variant is basically identically with that of the first two variants. In the following, therefore, only the design of the display means 6 that differs from the embodiments already described, as well as their cooperation with member 4 of the linear time display will be described.

It can be seen from FIGS. 7a to 7d that in this third embodiment, a so-called double pointer 6.4 is forced onto a pivot 6.5.1 by means of a pipe 6.4.1, analogously to what is done in the case of classical hands of timepieces, while the pivot in turn is attached to a pointer support 6.5, advantageously a T-shaped crossbeam. This T-shaped crossbeam 6.5 serves as a linear turning means, and is held with small play in a corresponding groove having a somewhat larger cross section that is T-shaped as well and extends transversely to the direction of the guiding means 3 on the surface of slide 4.1, in such a way that it can be moved to and fro in a plane that is parallel to the plane of the dial, perpendicularly to the direction of motion of member 4 that is attached on the guiding means 3. It follows that this movement is parallel to that of crossbar 4.2. Through said pivot 6.5.1 and through the control pin 4.2.1, respectively, and via two holes which in this variant are provided at reversing lever 4.3, crossbeam 6.5 and crossbar 4.2 are connected with said lever in a form-locking way.

A lateral shift of the guide beam and of crossbar 4.2, respectively, which as described above at first occurs continuously because of the conical ends of screws 5.2, 5.3 and/or the positioning pins 1.2, and then as a jump, i.e., at least partially in an instantaneous manner because of the action of catch 4.4 at carriage 4.1 shown in FIG. 4c, thus provokes a synchronous lateral shift of crossbeam 6.5. However, the lateral shift of cross-beam 6.5 could also be designed to be entirely continuous. At any rate, beam 6.5 and the double pointer 6.4 attached to it, move simultaneously with and in the same direction as guide beam 4.2, while the extent of linear movement of the crossbeam 6.5 and double pointer 6.4, respectively, relative to the extent of linear movement of the guide beam 4.2 can be selected by the ratio of the distance between pivot 6.5.1 and the point of attachment 4.3.1 of the reversing lever 4.3 to the distance between control pin 4.2.1 and the point of attachment 4.3.1.

It is symbolically indicated in the top view of FIG. 7a by dashed lines and arrows at the two scale ends that at the end of the linear movement along one scale section 2.1, 2.2, double pointer 6.4 is shifted to the other scale section, by a linear turn perpendicularly to said movement in order to then move in the opposite direction along this scale section, and so on. The center of the double pointer 6.4 with pipe 6.4.1 thus follows a rectangular path above the plane of the dial, contrary to the accustomed constellation of common wristwatches.

In addition, a direction indicator 4.3.4 filling two functions may be attached to the reversing lever 4.3. The indicator 4.3.4 firstly is used, as already indicated by its name, to emphasize the current position of double pointer 6.4, inasmuch as in the embodiments described, the horizontal shift of the double pointer 6.4 will only be a few millimeters in wristwatches, in view of their small size. In addition, this direction indicator 4.3.4 serves as a spring holding crossbeam 6.5 in its guide groove in slide 4.1. As an alternative, of course, this guide groove in slide 4.1 and/or the shape of the cross section of crossbeam 6.5 could be changed in an appropriate way so as to secure the attachment of crossbeam 6.5. This serves to eliminate unnecessary friction between parts by avoiding a raising of crossbeam 6.5, so that reversing lever 4.3 may pivot more freely about its point of rotation 4.3.1.

In FIG. 8, a variant of the display module 6 with double pointer 6.4 that can be shifted linearly in order to turn over to the other scale section 2.1, 2.2 is shown which advantageously needs fewer parts than the embodiment according to FIGS. 7a to 7d. In this case the double pointer 6.4 is attached directly to a crossbar 4.2, here of somewhat different design and having a projection serving to fix the double pointer 6.4. However, depending on the absolute size of the linear time display, the lateral shift of double pointer 6.4 in this variant might perhaps amount to less than 1 mm in a wristwatch, which under normal conditions would be almost imperceptible to the naked eye. Moreover, a catch 4.4 is shown in FIG. 8 which, as in the first two embodiments, secures an at least partially instantaneous turning of the display means 6.

This third variant of a linear time display may again serve as a minutes display, or in the context of one of the other display functions mentioned above.

It is possible, moreover, to optimize the functioning of a linear time display according to the invention, by a number of improvements of the different parts in all variants described.

On the one hand, crossbar 4.2 may have ends of concave shape adapted to the cross section of screws 5.2, 5.3, as shown in FIG. 7c, so that it can also be positioned as if shifted parallel to the line connecting the centers of the screws. This serves to prevent an undesirable simultaneous engagement in both screws 5.2, 5.3 in a given position of cross-bar 4.2. Thus, depending on the location of crossbar 4.2 in space relative to the line connecting the centers of the screws, the design of its ends can be adjusted by a radial shape.

On the other hand, it is important in such a display device to provide the best possible display accuracy. Where pointers exist for the hours as well as for the minutes, which has not been represented in the figures, the indication of the double pointer for the hours must agree with that of the pointer for minutes, very clearly for instance at 12 o'clock. The display accuracy is also known as display tolerance, and will depend more particularly on the size of tolerances present in the mechanism, primarily the fitting tolerances and the safe distances between parts and groups of parts which are needed to secure the functioning of the display mechanism. As an illustration, we may mention for instance the end play of screws 5.2, 5.3 in frame 1.1, the angular play of screws 5.2, 5.3 that depends on tooth play with the driving gear train 5.1, the tilt play between guide rail 3.1 and slide 4.1, the play between crossbar 4.2 and the helical threads of screws 5.2, 5.3, etc.

It must be guaranteed by possible design options that the display position of the pointer for the hours has at least an accuracy of about ±12 minutes, which corresponds to the distance between marks on an ordinary dial divided into 60 minutes.

At the level of product design already, different measures may be taken in order to counteract potential inaccuracies in the display. For instance, rather than placing line marks having a certain length on scales 2.1, 2.2, one could apply round dots having a larger diameter, or omit the marks altogether. The resulting reading inaccuracy can be balanced by a separate display of the minutes.

At the level of mechanical layout, moreover, one may attempt to keep the tolerances present throughout the mechanism as small as possible so that the accuracy of the display will be affected to the smallest possible extent by shifts between individual parts.

The design solutions that are applicable here may be highly diversified, and often include elastic elements. These have the disadvantage, though, to raise friction between the parts, and thus are in contrast to the above condition to reduce friction between the parts. Therefore, such elastic elements will not be described any further in what follows.

Another possible solution provides for small raised areas 2.1.1, 2.2.1 on the surfaces of time scales 2.1, 2.2 facing the pointer 6.1 or double pointer 6.4, as well as on their surfaces facing the guide rail 3.1, so that the end(s) of the pointer may be supported by said raised areas. This means that during the to-and-fro movement of slide 4.1 along the scale sections 2.1, 2.2 the ends of the pointer will be dragged along the surface of one of the raised areas 2.1.1, 2.2.1, and will be supported by it. This is shown in FIG. 7c, and serves to limit a rotary motion of slide 4.1 on a guide rail 3.1 having e.g. a circular section, thus reducing the tilt play between guide rail 3.1 and slide 4.1 that had been mentioned above. The tilting of slide 4.1 will then be hardly perceptible to the naked eye inasmuch as the distance between the pointer ends and the surface of these raised areas 2.1.1, 2.2.1 is just a few tenths of a millimeter.

As an alternative, again shown in FIG. 7c, the linear time display may include a plate 3.3 that is arranged beneath guide rail 3.1 and covers the entire length of this rail, so that one of the lower edges of slide 4.1 will be dragged along the surface of plate 3.3 in case the slide during its to-and-fro movement is slightly tilted. This means that slide 4.1 is held on guide rail 3.1 while being secured against torsion by plate 3.3.

The same purpose that is served by the above raised areas 2.1.1, 2.2.1 or by plate 3.3, can of course also be served by a guide rail 3.1 having square or polygonal cross section, and matched design of slide 4.1, as shown in the first two sketches in FIG. 9. However, in practice, such an anti-torsion protection is difficult to produce on account of the small dimensions, where sides less than 1 mm would be needed for instance in a wrist-watch. However, a guide rail 3.1 of rectangular cross section having a side measuring more than 2 mm, and a smaller height of for instance less than 1 mm, can also be produced in smaller dimensions. In larger timepieces such as those for instrument panels in vehicles or for table clocks where the dimensions are less problematic, square guide rails 3.1 can certainly be considered.

To counteract tilting, apart from the measures cited above, slide 4.1 may further include at least two friction bearings 4.1.1 such as those commonly used in watchmaking wherever the longitudinal orientation of a part or group of parts requires very high precision. Ordinarily, for reasons of manufacturing technology and cost, the friction bearings 4.1.1 are arranged at the two ends of slide 4.1 between it and guide rail 3.1, as shown for instance in FIG. 7d. Depending on size, the two bearings 4.1.1 may for instance be in the shape of generally known roller bearings. A lateral opening 4.1.2 in slide 4.1 will serve to clean the friction bearings 4.1.1 in after-sales service.

The cross section of guide rail 3.1 may have flattened portions 3.1.1 on one or several sides, see FIG. 9, in order to avoid oil being wiped away from the surface of guide rail 3.1 by friction bearings 4.1.1 or slide 4.1. Care must be taken here that in the guiding surface that for instance is circular, at least two parts remain which in the cross section of guide rail 3.1 are symmetric to each other, so that a correct sliding motion of slide 4.1 is secured. Instead of a flattened portion having the shape of an elongated area 3.1.1, one might also imagine a groove or recess serving as oil reservoir for lubrication of guiding means 3.

It must also be mentioned in the context of friction bearings 4.1.1 and of the cross-sectional shape of guide rail 3.1 that a square or polygonal shape—in contrast to a rail of circular cross section—generally implies the disadvantage of friction bearings 4.1.1 having a two-point support. By three-point spatial support together with the second friction bearing 4.1.1, the risk of tilt thus is raised when tolerances have been chosen that are too narrow, or a larger lateral tilt will be produced when the tolerances are large. It is an additional disadvantage of a square or polygonal guide rail 3.1 that seen in cross section, the orientation of slide 4.1 depends on it, making assembly more difficult. In summary, it may be said in this respect that square or polygonal guides are beset by many technical problems while round guide rails 3.1 cooperating with the slide and friction bearings 4.1.1 offer the advantage in assembly that an alignment of flattened sides 3.1.1 is not required, and thus has no influence on the slide 4.1, its orientation being determined separately, either by the pointer ends or by the lower edges of the slide. Therefore, a tilting of slide 4.1 is practically impossible because of two-point space support in friction bearings 4.1.1 on a rail 3.1 of round cross section.

It is emphasized by these explanations that in a time display according to the present invention, it is clear at all times from the display which scale section is to be read. Moreover, only linear scale sections are visible, which enhances the aesthetic effect. These linear scale sections moreover offer large freedom of design, since the turning motion occurs, either as a rotary motion pointing toward the center of the time display device, or as a linear motion perpendicularly to the direction of motion of the member attached to the guiding means.

1. Time display device (1) with at least one linear scale (2) having at least two parallel scale sections (2.1, 2.2) arranged side by side, with divisions applied in opposite directions, with guiding elements (3) running between these sections, with at least one member (4) attached to the guiding elements and movable along the linear scale sections, with driving means (5) moving this member, and with display means (61 attached to said member for the display of time on the scale sections, characterised in that the display means (6) are attached in such a way to said member (4) that they will turn from one scale section to the other. each time when reaching an end of a linear scale section (2.1, 2.2). this turn occurring at least partially in a jumping and instantaneous manner.

2. Time display device according to claim 1, characterised in that the display means (6) are attached in such a way to said member (4) that when reaching any of the ends of a linear scale section (2.1, 2.2) they will turn entirely in a jumping and instantaneous manner to the scale section running parallel to it.

3. Time display device according to claim 1 characterised in that the display means (6) are attached in such a way to said member (4) that the turn occurs as a rotary motion in a direction perceptibly pointing towards the centre of the time display device (1).

4. Time display device according to claim 1, characterised in that the display means (6) comprise a pointer (6.1).

5. Time display device according to claim 1, characterised in that the display means (6) comprise turning means for the turning of pointer (6.1) which include a variable transmission (6.2) and a motion work (6.3).

6. Time display device according to claim 5, characterised in that the variable transmission (6.2) includes a toothed control disc (6.2.1), and the motion work (6.3) includes a clutch disc (6.3.1), at least a first pinion (6.3.3), a second pinion (6.3.4), and a pointer pinion (6.3.5) holding the pointer (6.1), where depending on the position of clutch disc (6.3.1) the first pinion (6.3.3) or the second pinion (6.3.4) engage with the control disc (6.2.1) and drive the pointer pinion (6.3.5) with pointer (6.1).

7. Time display device according to claim 1, characterised in that the guiding means (3) include a guide rail (3.1) running between the scale sections.

8. Time display device according to claim 1, characterised in that the guiding means (3) include a control rail (3.2) running between the scale sections and having a diagonal guide groove (3.2.1).

9. Time display device according to claim 1, characterised in that the driving means (5) include at least one screw (5.2, 5.3) arranged in parallel to the guiding means and having a helical thread.

10. Time display device according to claim 9, characterised in that the driving means (5) include two screws (5.2, 5.3) attached on either side of the guiding means (3).

11. Time display device according to claim 10, characterised in that the member (4) movably attached to the guiding means (3) is designed as a slide (4.1).

12. Time display device according to claim 11, characterised in that slide (4.1) has reversing means including a movable guide beam (4.2) able to engage in turns with one of the oppositely running threads of the two screws (5.2, 5.3) and thus reversing the direction of motion of slide (4.1).

13. Time display device according to claim 12, characterised in that the reversing means of slide (4.1) include a pivoted reversing lever (4.3) that cooperates with the movable guide beam (4.2) via a control pin (4.2.1) sitting on the guide beam.

14. Time display device according to claim 13, characterised in that the reversing means of slide (4.1) comprise control means for the movable guide beam (4.2) that include conical ends of the screws (5.2. 5.3) and/or positioning pins (1.2).

15. Time display device according to claim 13, characterised in that the reversing means of slide (4.1) include an elastic element (4.4) attached to member (4) as a means for an at least partly sudden and instantaneous reversal of reversing lever (4.3).

16. Time display device according to claim 13, characterised in that the elastic element attached to member (4) is designed as a catch (4.4) cooperating with the reversing lever (4.3) in such a way that after prior action of said control means on the movable guide beam (4.2) the force of catch (4.4) will produce a reversal of reversing lever (4.3) into its other extreme position as well as a jump of pointer (6.1) from one scale section (2.1, 2.2) to the other.

17. Time display device according to claim 13, characterized in that the guiding means (3) include a control rail (3.2) running between the scale sections and having a diagonal guide groove (3.2.1), and the reversing means of slide (4.1) include a pretensioning spring (4.3.2) the ends of which are connected with the reversing lever (4.3) and with a spring plate (4.3.3) pivoted around the point of attachment (4.3.1) of the reversing lever. the spring plate cooperating with the diagonal guide groove (3.2.1) of control rail (3.2) in such a way that a linear motion of slide (4.1) will cause a tensioning of the pretensioning spring (4.3.2) by a rotation of spring plate (4.3.3).

18. Time display device according to claim 17, characterized in that the variable transmission (6.2) includes a toothed control disc (6.2.1), and the motion work (6.3) includes a clutch disc (6.3.1), at least a first pinion (6.3.3), a second pinion (6.3.4), and a pointer pinion (6.3.5) holding the pointer (6.1), where depending on the position of clutch disc (6.3.1) the first pinion (6.3.3) or the second pinion (6.3.4) engage with the control disc (6.2.1) and drive the pointer pinion (6.3.5) with pointer (6.1), and the clutch disc (6.3.1) of motion work 6.3) cooperates with the diagonal guide groove (3.2.1) of control rail (3.2) in such a way that a linear motion of slide (4.1) will cause an engagement or disengagement of the first pinion (6.3.3) or the second pinion (6.3.4) of motion work (6.3) with the toothed control disc (6.2.1) of variable transmission (6.2) by a rotation of clutch disc (6.3.1).

19. Time display device according to claim 14, characterised in that the reversing lever (4.3) is held in one of two extreme positions by a catch (6.2.2) engaging in one of two recesses of the toothed control disc (6.2.1) of variable transmission (6.2) until the force of catch (6.2.2) is overcome by the positioning pins (1.2) that act on the arms of reversing lever (4.3) through the linear motion of slide (4.1), and the force of pretensioning spring (4.3.2) will produce a reversal of reversing lever (4.3) to the other extreme position as well as a jump of pointer (6.1) from one scale section (2.1. 2.2) to the other.

20. Time display device (1) with at least one linear scale (2) having at least two parallel scale sections (2.1. 2.2) arranged side by side, with divisions applied in opposite directions, with guiding elements (3) running between these sections, with at least one member (4) attached to die guiding elements and movable along the linear scale sections, with driving means (5) moving this member, and with display means (6) attached to said member for the display of time on the scale sections, characterised in that the display means (6) are attached in such a way to said member (4) that they will turn from one scale section to the other, each time when reaching an end of a linear scale section (2.1, 2.2), this turn occurring via a linear motion of the display means (6).

21. Time display device according to claim 20, characterised in that the turn occurs via a linear motion of the display means (6) occurring perpendicularly to the direction of motion of the member (4) attached to guiding means (3).

22. Time display device according to claim 20, characterised in that the display means (6) comprise a double pointer (6.4).

23. Time display device according to claim 22 characterized in that the display means (6) comprise turning means for turning of the double pointer (6.4) that include a pointer support (6.5) movable perpendicularly to the direction of motion of member (4) attached to guiding means (3).

24. Time display device according to claim 23, characterized in that the pointer support (6.5) is supported in a groove cut across the direction of extension of guiding means (3) into the surface of member (4) in such a way that it can he moved to and fro in a plane parallel to the plane of the dial, and perpendicularly to the direction of motion of member (4) attached to guiding means (3).

25. Time display device according to claim 20, characterised in that the turn will occur at least partially in a jumping and instantaneous manner.

26. Time display device according to claim 25, characterised in that the turn that occurs at least partially in a jumping and instantaneous manner, is produced by an elastic element (4.4) attached to member (4).

27. Time display device according to claim 20, characterized in that the guiding means (3) include a guide rail (3.1) running between the scale sections.

28. Time display device according to claim 20, characterised in that the driving means (5) include at least one screw (5.2, 5.3) with helical thread arranged in parallel to the guiding means.

29. Time display device according to claim 28, characterized in that the driving means (5) include two screws (5.2. 5.3) attached on either side of guiding means (3).

30. Time display device according to claim 20, characterised it that the member (4) movably attached to the guiding means (3) is designed as a slide (4.1).

31. Time display device according to claim 30, characterized in that slide (4.1) has reversing means including a movable guide beam (4.2) able to engage in turns with one of the oppositely running threads of the two screws (5.2, 5.3) and thus reversing the direction of motion of slide (4.1).

32. Time display device according to claim 31 characterised in that the reversing means of slide (4.1) include a pivoted reversing lever (4.3) that cooperates with the movable guide beam (4.2) via a control pin (4.2.1) sitting on the guide beam.

33. Time display device according to claim 31, characterized in that the reversing means of slide (4.1) comprise control means for the movable guide beam (4.2) that include conical ends of the screws (5.2, 5.3) and/or positioning pins (1.2).

34. Time display device according to claim 32, characterized in that the reversing means of slide (4.1) include an elastic element (4.4) attached to member (4) as a means for an at least partially jumping and instantaneous reversal of the reversing lever (4.3).

35. Time display device according to claim 32, characterised in that the elastic element attached to member (4) is designed as a catch (4.4) cooperating with the reversing lever (4.3) in such a way that after prior action of said control means on the movable guide beam (4.2) the force of catch (4.4) will produce a reversal of reversing lever (4.3) into its other extreme position as well as a jump of double pointer (6.4) from one scale section (2.1. 2.2) to the other.

36. Time display device according to claim 35, characterised in that the pointer support (6.5) and the guide beam (4.2) are form-locking with reversing lever (4.3) via a pivot (6.5.1) or via control pin (4.2.1) and two openings in the reversing lever, so that they will provoke the switch of the guide beam and the turning of the double pointer (6.4) that is attached to the pointer support (6.5), by a reversal of reversing lever (4.3).

37. Time display device according to claim 32, characterized in that the reversing level (4.3) includes a direction indicator (4.3.4) indicating the position of reversing lever (4.3) as welt as that of double pointer (6.4).

38. Time display device according to claim 31, characterized in that the display means (6) comprise a double pointer (6.4) is attached to the movable guide beam (4.2).

39. Time display device according to claim 12, characterised in that at its ends, the movable guide beam (4.2) has a concave shape adapted to the cross section of screws (5.2, 5.3).

40. Time display device according to claim 6, characterised in that on the surface of scale sections (2.1, 2.2) facing the pointer (6.1) or the double pointer (6.4), projections (2.1.1, 2.2.1) supporting the pointer ends are provided.

41. Time display device according to claim 11, characterised in that for stabilization of slide (4.1), it includes a plate (3.3) attached beneath the guide rail (3.1) and extending over the entire length of the rail.

42. Time display device according to claim 7, characterised in that as a safeguard against twisting, the guide rail (3.1) has a square or polygonal cross section.

43. Time display device according to claim 7, characterised in that guide rail (3.1) includes at least one flattened side (3.1.1) or a groove.

44. Time display device according to claim 11, characterized in that slide (4.1) is provided with a friction bearing (4.1.1) at each of its ends.

45. Watch, and particularly a wristwatch, characterized in that it includes a time display device (1) according to claim 1.

46. Watch according to claim 45, characterised in that the time display device (1) is attached with a slight tilt relative to the plane of movement of the watch.

47. Watch according to claim 45, characterised in that the time display device (1) is pivoted in its plane of attachment and can be adjusted in its angular position.
